(19) United States
(12) Patent Application Publication
(10) Pub. No.: US 2022/0355769 A1
(43) Pub. Date: Nov. 10, 2022

(54) Trailer Crank Extension Device for Automated Raising and Lowering of a Trailer

(71) Applicant: Albert W. MacDonald, Delray Beach, FL (US)

(72) Inventor: Albert W. MacDonald, Delray Beach, FL (US)

(21) Appl. No.: 17/307,892

(22) Filed: May 4, 2021

(51) Int. Cl. B60S 9/08

(52) U.S. Cl. CPC B60S 9/08

(57) ABSTRACT

A trailer crank extension device for automated raising and lowering of a trailer automates the raising and lowering of a trailer by detachably mounting to a trailer crank, and coupling to a rotary tool that transfers torque, through the rod, to the rotatable drive shaft in the trailer crank. The device includes a rod having a male end and an opposing female end. The female end of the rod has a channel that receives and detachably fastens to a rotatable drive shaft of trailer crank. The male end comprises a geometric-shaped terminus, and projects out to engage and grip the chuck of a rotary tool. A cylindrical clamp removably encapsulates and fastens the female end of the rod with rotatable drive shaft of trailer crank. A rotary tool couples to the male end of rod to rotate, and thereby transfer torque, to the rotatable drive shaft, through the rod.

### FIELD OF THE INVENTION

The present invention relates generally to a trailer crank extension device for automated raising and lowering of a trailer. More so, the present invention relates to a trailer crank accessory that automates raising and lowering of a trailer by detachably coupling to the rotatable drive shaft of a trailer crank, and receiving a rotary tool that transfers torque, through the extension device, to the rotatable drive shaft in the crank of the trailer for raising and lowering the trailer.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, a trailer includes a crank, or jack, such as a crank style drop leg jack. Such a trailer crank is used to manually raise and lower the trailer, often with a rotatable motion by the trailer user. However, this type of manually operated jack is often disfavored because of the amount of time and effort it takes to raise and lower the trailer. It is also possible to install an electric assist trailer jack. However, often times this is problematic because of the substantial time it may take to lift and lower the trailer in such a manner.

It is known in the art that the original manufacturer jack can be removed and replaced with a hydraulic jack. However, there are problems with doing so. For example, the time and expense of the install and rework necessary to install a hydraulic jack and the possibility of weakening the tongue or frame of the trailer as a result of the install are problematic. Such a retrofit involves cutting into the trailer, damaging the powder coating, paint or other finish of the trailer. Thus, this solution is particularly disfavored when the trailer is new or in good condition. Trailer manufacturers often provide trailers with the crank style drop leg jacks and provide an option of hydraulic jacks. However, the hydraulic option has issues with leaking hydraulic fluid after a duration.

Known drill chucks generally include a chuck body, gripping jaws, ring nut, nut sleeve, bearing, front sleeve, rear sleeve, etc. The gripping jaws are fitted to the three corresponding inclined holes on the chuck body. The ring nut is fitted inside the ring nut groove of the chuck body and the thread of the ring nut and gripping jaw combine to form a screw gear. The nut sleeve and the nut are generally fixed to each other. The front sleeve is fitted to the nut or the nut sleeve. The rear sleeve is fitted to the chuck body permanently or otherwise. At the rear part of the chuck body there is a threaded hole or a taper hole. The threaded hole of the chuck body is connected to the shaft of a power drill, so that when the drill shaft turns, it will drive the chuck jaws to turn together as well as the drill tool clamped by the jaws.

Other proposals have involved device that raise and lower trailers by engaging the trailer crank. The problem with these trailer crank devices is that they do not magnify the force applied to the rotary crank, and they are not compactable for all types of trailers. Also, the handle used to control the trailer crank device does not securely remain fixed to the trailer crank. Even though the above cited device that raise and lower trailers meets some of the needs of the market, a trailer crank extension device for automated raising and lowering of a trailer automates raising and lowering of a trailer by detachably coupling to the rotatable drive shaft of a trailer crank, and receiving a rotary tool that transfers torque, through the extension device, to the rotatable drive shaft in the crank of the trailer for raising and lowering the trailer, is still desired.

### SUMMARY

Illustrative embodiments of the disclosure are generally directed to a trailer crank extension device for automated raising and lowering of a trailer. The trailer crank extension device serves to automate the raising and lowering of a trailer by detachably mounting to a trailer crank, and receiving a rotary tool that transfers torque, through the rod, to the rotatable drive shaft in the crank of the trailer. This negates the need for manual labor to raise and lower the trailer.

In some embodiments, the extension device includes a rod having a male end and an opposing female end. The female end of the rod has a channel that receives and detachably fastens to a rotatable drive shaft of the trailer crank. The male end of the rod comprises a geometric-shaped terminus, and projects out, so as to engage and grip the chuck of the rotary tool. The geometric-shaped terminus can have multiple angular sides designed to receive different types and styles of chucks and rotary tools, i.e., automatic drills. Once the rotary tool couples to the male end of the rod, the rotary tool can be rotated so as to transfer torque to the rotatable drive shaft of the trailer crank, through the rod.

A cylindrical clamp removably encapsulates the female end of the rod, with the rotatable drive shaft of the trailer crank. The cylindrical clamp enables universal attachment to various types of rotatable drive shafts, including vertical drive rods, horizontal drive rods, and drive rods for different companies and sizes. In this manner, the extension device provides an automated and efficient means to raise and lower trailer jacks, without stooping over, using muscles, or requiring excessive tools.

In one aspect, a trailer crank extension device, comprises:
a rod defined by a male end and a female end, the male end defining a geometric-shaped terminus, the female end defining a channel;
a cylindrical clamp configured to releasably fasten the female end of the rod to a rotatable drive shaft of a trailer crank, the cylindrical clamp comprising two sections adapted to at least partially encapsulate the female end of the rod and the rotatable drive shaft, the sections comprising a male end section and a female end section, the male end section comprising a texture for enhancing grip of the cylindrical clamp, the female end section defining a slot adapted to enable passage of at least a portion of the trailer crank, whereby the cylindrical clamp detachably attaches the rod to the rotatable drive shaft; and
a strap defined by a pair of free ends, the strap configured to at least partially wrap around the cylindrical clamp and the female end of the rod,
whereby the strap helps fasten the cylindrical clamp to the trailer crank.

In another aspect, the geometric-shaped terminus comprises a hexagonal shape.

In another aspect, the cylindrical clamp comprises a pipe clamp or a C-clamp.

In another aspect, the device further comprises multiple fasteners configured to fasten the free ends of the strap together.

In another aspect, the device further comprises a rotary tool, the rotary tool comprising a chuck having multiple jaws.

In another aspect, the rotary tool includes at least one of the following: a cordless drill, a benchtop drill press, a cordless drill, a hammer drill, a rotary hammer drill, and an impact drill, a mini drill, and a two-headed drill.

In another aspect, the chuck includes at least one of the following: a keyed chuck, a double-sleeve keyless chuck, a single-sleeve keyless chuck, an SDS chuck, and a hex connection.

In another aspect, the rod is configured for interposition between the chuck and the rotatable drive shaft.

In another aspect, the male end of the rod is configured to at least partially enter the chuck of the rotary tool.

In another aspect, the jaws are configured to grip the male end of the rod with radial symmetry.

In another aspect, the geometric-shaped terminus of the male end is configured to register with the jaws of the chuck in a snug relationship.

In another aspect, the rod has sufficient strength to transfer torque from the rotary tool to the rotatable drive shaft.

In another aspect, the trailer crank is operable to enable raising and lowering a trailer when the rod rotates the rotatable drive shaft.

In another aspect, the device further comprises multiple screws or bolts configured to press the sections of the cylindrical clamp together.

In another aspect, the rod includes at least one of the following materials: titanium, steel, iron, metal alloys, aluminum, and composite graphite.

One objective of the present invention is to automate the task of raising and lowering a trailer with a trailer crank.

Another objective is to provide an extension to the rotary drive shaft of the trailer crank that has a cross shape, so as to improve grip with the jaws of the chuck.

Yet another objective is to enable the extension device to be universal for mounting to multiple types and sizes of trailer cranks.

Additional objectives are to reduce stooping, bending over, and torque on the back while lowering and raising a trailer.

An exemplary objective is to provide an inexpensive to manufacture trailer crank extension device.

Other devices, devices, methods, features, and advantages will be or become apparent to one with skill in the art upon examination of the following drawings and detailed description. It is intended that all such additional devices, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary trailer crank extension device for automated raising and lowering of a trailer, showing the device engaging a trailer crank, in accordance with an embodiment of the present invention;

FIG. 2 illustrates a perspective view of an exemplary trailer with a trailer crank for raising and lowering the trailer, in accordance with an embodiment of the present invention;

FIG. 3 illustrates a perspective view of an exemplary rod oriented for introduction into the rotary drive shaft of the trailer crank, in accordance with an embodiment of the present invention;

FIG. 4 illustrates a perspective view of an exemplary horizontal trailer crank for raising and lowering the trailer, in accordance with an embodiment of the present invention;

FIG. 5 illustrates a perspective view of the rod oriented for introduction into the rotary drive shaft of the horizontal trailer crank, in accordance with an embodiment of the present invention;

FIG. 6 illustrates a perspective view of an exemplary cylindrical clamp positioned to slide onto the rotary drive shaft of the trailer crank, in accordance with an embodiment of the present invention;

FIG. 7 illustrates a perspective view of an exemplary strap fastening the cylindrical clamp to the trailer crank, in accordance with an embodiment of the present invention; and

FIG. 8 illustrates a close-up view of exemplary fasteners fastening the free ends of the strap around the trailer crank and the rod, in accordance with an embodiment of the present invention.

Like reference numerals refer to like parts throughout the various views of the drawings.

### DETAILED DESCRIPTION OF THE INVENTION

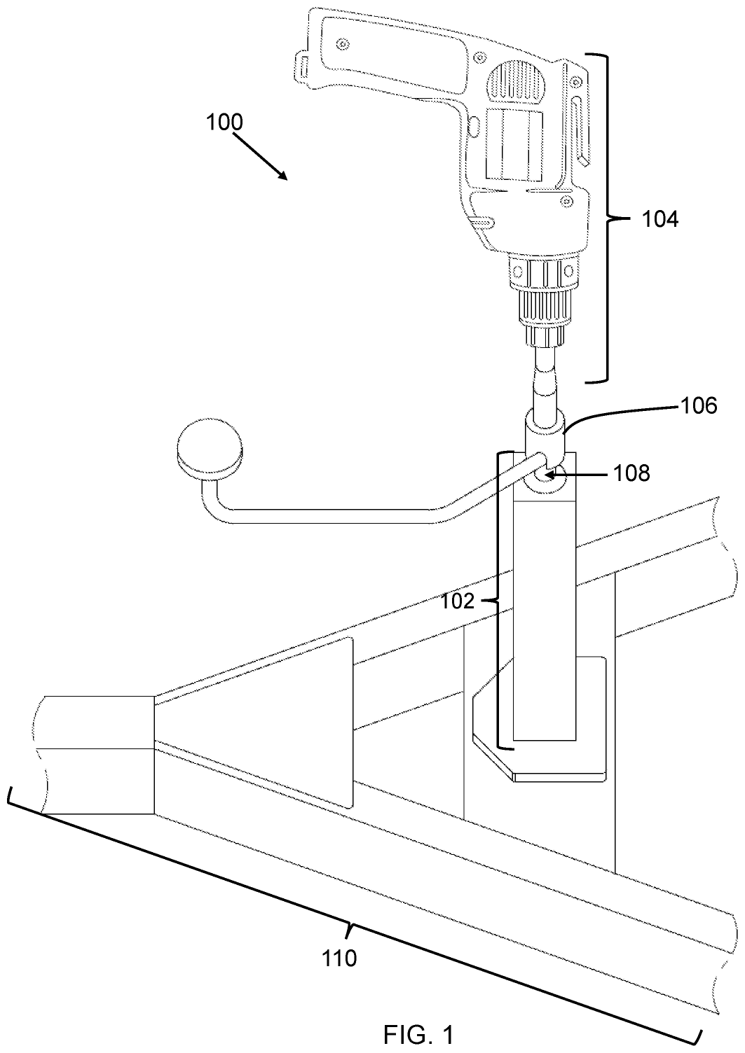

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A trailer crank extension device 100 for automated raising and lowering of a trailer is referenced in FIGS. 1-8. The trailer crank 102 extension device 100, hereafter “device 100” is a unique accessory that securely couples to a rotatable drive shaft 200 of the trailer crank 102, and transfers torque from a rotary tool 104 to enable automated raising and lowering of a trailer 110. This helps reduce stooping, bending over, and torque on the back while lowering and raising the trailer 110.

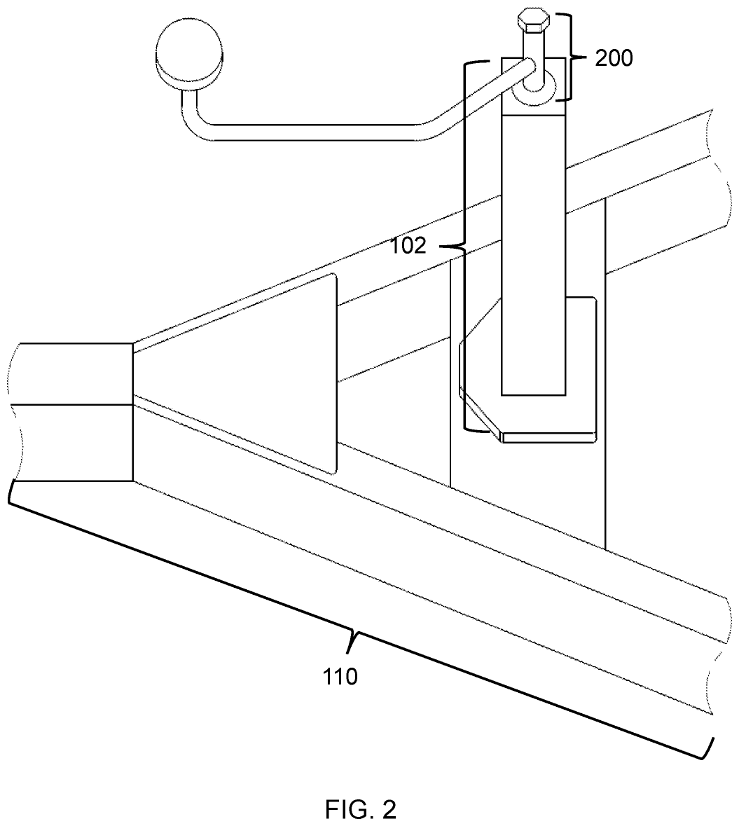

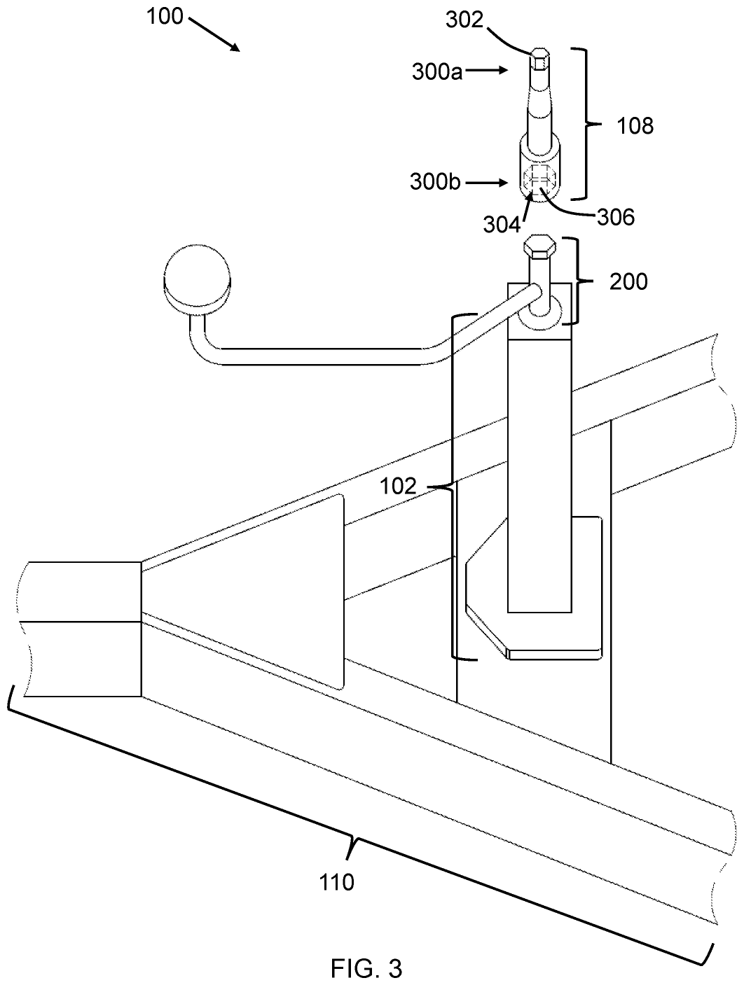

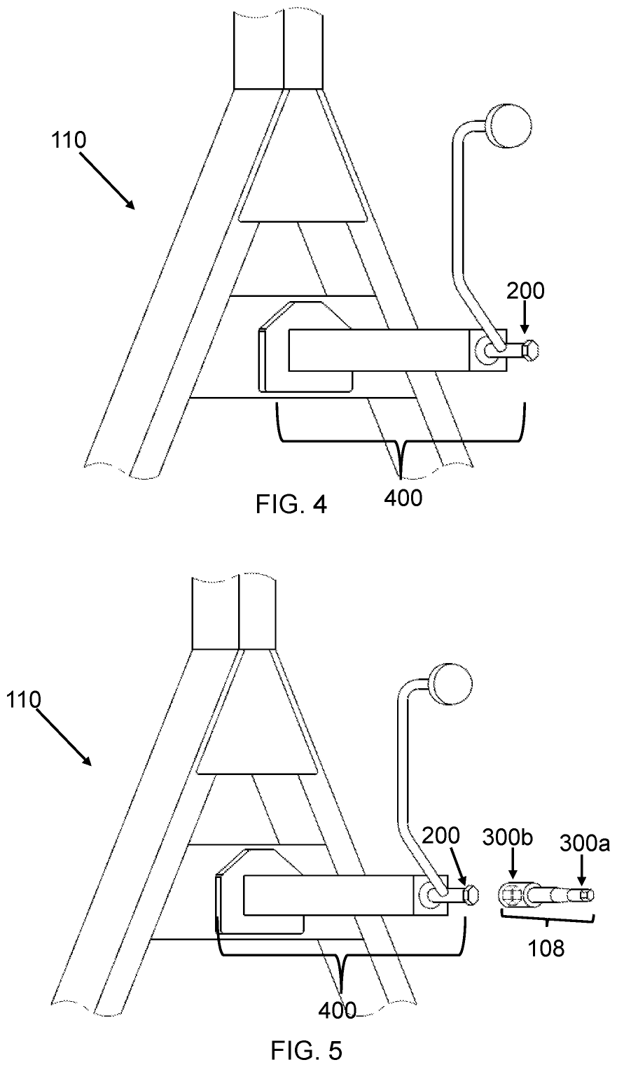

Looking initially at FIG. 1, the device 100 includes a rod 108 that serves as the structural unit for transferring torque from a rotary tool 104 to the rotatable drive shaft 200 of the trailer crank 102. In some embodiments, the rod 108 may be fabricated with at least one of the following materials: titanium, steel, iron, metal alloys, aluminum, and composite graphite. The rod 108 is generally linear, with a wide female end 300b, and a male end 300a being narrower or lesser diameter than the female end 300b. In a vertical configuration, shown in FIGS. 2 and 3, the male end 300a orients upwardly, and is distally positioned from the rotatable drive shaft 200 of the trailer crank 102. The female end 300b orients downwardly, and is proximal to the rotatable drive shaft 200. In a horizontal configuration of trailer crank 400, the male end 300a projects outwardly from the rotatable drive shaft 200; while the female end 300b abuts the rotatable drive shaft 200 (See FIGS. 4 and 5).

In some embodiments, the male end 300a of the rod 108 comprises a geometric-shaped terminus 302, and projects out, so as to engage and grip the chuck 106 of the rotary tool 104. In some embodiments, the geometric-shaped terminus 302 may be a hexagonal shape. However, other shapes, including irregular shapes may also be used, such as an octagon, a square, and a triangle. The geometric-shaped terminus 302 can have multiple angular sides designed to receive different types and styles of chucks and rotary tools, i.e., automatic drills. Once the rotary tool 104 couples to the male end 300a of the rod 108, the rotary tool 104 can be rotated so as to transfer torque to the rotatable drive shaft 200 of the trailer crank 102, through the rod 108.

As shown in FIG. 3, the female end 300b of the rod 108 forms a channel 304 that receives and enables detachable attachment to a rotatable drive shaft 200 of the trailer crank 102. Similar to the terminus of the male end 300a, the inner surface of the channel 304 may also have a geometric shaped inner surface 306 that forms a snug fit relationship with the rotatable drive shaft 200, or a nut or fastening mechanism at the terminus of the rotatable drive shaft 200. For example, a head of a hex screw at the terminus of the rotatable drive shaft 200 is easily introduced into the channel 304 of the female end 300b. However, other shapes, including irregular shapes may also be used, such as an octagon, a square, and a triangle. The geometric-shaped inner surface 306 can have multiple angular sides designed to receive different types and styles of nuts from rotary drive shaft 200.

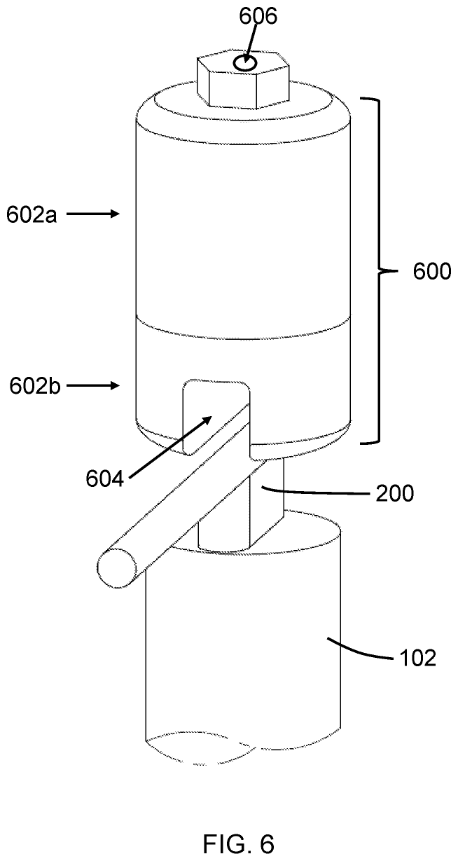

The device 100 also includes a cylindrical clamp 600 that removably encapsulates the female end 300b, or the male end 300a, or both, of the rod 108 with the rotatable drive shaft 200 of the trailer crank 102. FIG. 6 illustrates the cylindrical clamp 600 positioned to slide onto the rotary drive shaft of the trailer crank. In some embodiments, the cylindrical clamp 600 comprises a pipe clamp or a C-clamp. The cylindrical clamp 600 enables universal attachment to various types of rotatable drive shaft 200s, including vertical drive rods, horizontal drive rods, and trailer rotary drive rod 108s configured for different companies and sizes. In this manner, the device 100 provides an automated and efficient means to raise and lower trailer jacks, without stooping over, using muscles, or requiring excessive tools.

In one possible embodiment, the cylindrical clamp 600 is configured to releasably fasten the female end 300b of the rod 108 to a rotatable drive shaft 200 of a trailer crank 102. The cylindrical clamp 600 comprises two sections that are adapted to at least partially encapsulate the female end 300b of the rod 108 and the rotatable drive shaft 200. In one non-limiting embodiment, a male end section 602a extends to the male end 300a, and a female end section 602b extends to female end 300b.

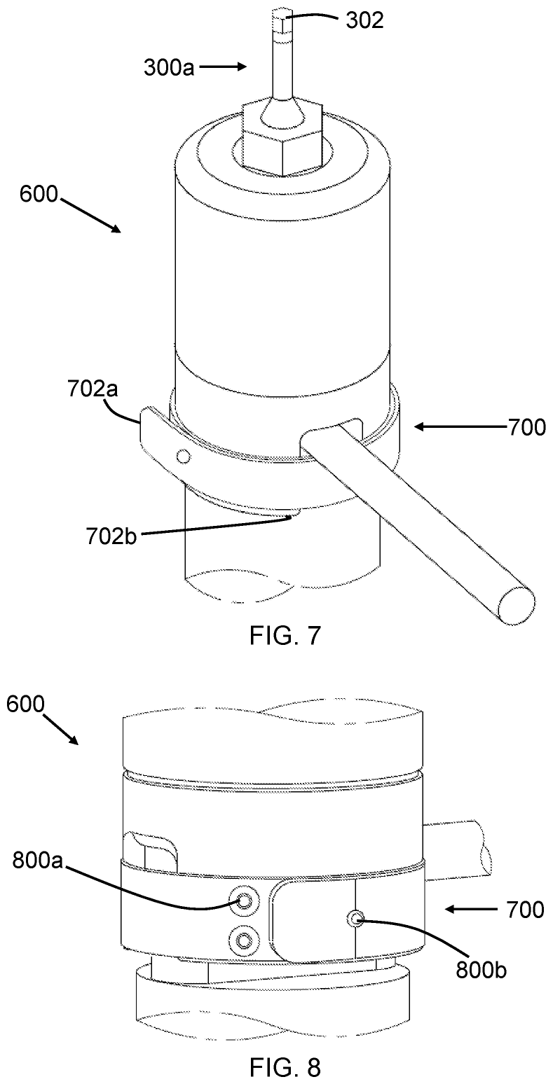

In another embodiment, the male end section 602a comprises a texture for enhancing grip of the cylindrical clamp 600. This can include a swirling pattern that helps the hand of the user in manipulating and fitting the cylindrical clamp 600 to the rod 108. In other embodiments, the female end section 602b defines a slot 604 adapted to enable passage of at least a portion of the trailer crank 102. A tunnel 606 may form concentrically through the cylindrical clamp 600 to enable passage of rod 108 and rotatable drive shaft 200 (See FIG. 7). In this manner, cylindrical clamp can be slidably placed over rod 108 and rotatable drive shaft 200.

As FIG. 8 illustrates, the device 100 also includes a strap 700 defined by a pair of free ends 702a, 702b. The strap 700 is configured to at least partially wrap around the cylindrical clamp 600 and the female end 300b of the rod 108. In some embodiments, the device 100 further comprises multiple fasteners 800a, 800b configured to fasten the free ends 702a-b of the strap 700 together; thereby securing the cylindrical clamp 600 to the rod 108 and the trailer crank 102. The fasteners, which may include screws or bolts are configured to press the sections of the cylindrical clamp 600 together. When fitted in this manner, the strap 700 helps fasten the cylindrical clamp 600 to the trailer crank 102. In this manner, the cylindrical clamp 600 detachably attaches the rod 108 to the rotatable drive shaft 200.

Looking again at FIG. 1, the device 100 also includes a rotary tool 104, which is the means for transferring torque from the rotary tool 104 to the rotatable drive shaft 200. In some embodiments, the rotary tool 104 may include, without limitation, a cordless drill, a benchtop drill press, a cordless drill, a hammer drill, a rotary hammer drill, and an impact drill, a mini drill, and a two-headed drill. In some embodiments, the chuck 106 may include, without limitation, a keyed chuck, a double-sleeve keyless chuck, a single-sleeve keyless chuck, an SDS chuck, and a hex connection. It is also significant to note that the rod 108 and the clamp 600 can be used with a universal, or off-the-shelf rotary tool 104; whereby the rotary tool 104 is not part of the device 100.

In some embodiments, the rotary tool 104 includes a chuck 106 having multiple jaws. The rod 108 is configured for interposition between the chuck 106 and the rotatable drive shaft 200. The male end 300a of the rod 108 is configured to at least partially enter the chuck 106 of the rotary tool 104. The jaws are configured to grip the male end 300a of the rod 108 with radial symmetry. The geometric-shaped terminus 302 of the male end 300a is configured to register with the jaws of the chuck 106 in a snug relationship. Thus, by rotating the rotary tool 104, in an automated manner, the trailer crank 102 is operable to enable raising and lowering a trailer when the rod 108 rotates the rotatable drive shaft 200.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A trailer crank extension device, the device comprising:
a rod defined by a male end and a female end, the male end defining a geometric-shaped terminus, the female end defining a channel;
a cylindrical clamp configured to encapsulate at least a portion of the female end of the rod and at least a portion of a rotatable drive shaft of a trailer crank, the cylindrical clamp comprising two sections adapted to at least partially encapsulate the female end of the rod and the rotatable drive shaft, the sections comprising a male end section and a female end section, the male end section comprising a texture for enhancing grip of the cylindrical clamp, the female end section defining a slot adapted to enable passage of at least a portion of the trailer crank,
whereby the cylindrical clamp detachably attaches the rod to the rotatable drive shaft; and
a strap defined by a pair of free ends, the strap configured to at least partially wrap around the cylindrical clamp and the female end of the rod,
whereby the strap helps fasten the cylindrical clamp to the trailer crank.

2. The device of claim 1, wherein the cylindrical clamp forms a tunnel for enabling passage of the rod and the rotatable drive shaft therethrough.

3. The device of claim 1, wherein the geometric-shaped terminus comprises a hexagonal shape.

4. The device of claim 1, further comprising multiple fasteners configured to fasten the free ends of the strap together.

5. The device of claim 1, further comprising a rotary tool, the rotary tool comprising a chuck having multiple jaws.

6. The device of claim 5, wherein the rotary tool includes at least one of the following: a cordless drill, a benchtop drill press, a cordless drill, a hammer drill, a rotary hammer drill, and an impact drill, a mini drill, and a two-headed drill.

7. The device of claim 5, wherein the chuck includes at least one of the following: a keyed chuck, a double-sleeve keyless chuck, a single-sleeve keyless chuck, an SDS chuck, and a hex connection.

8. The device of claim 5, wherein the rod is configured for interposition between the chuck and the rotatable drive shaft.

9. The device of claim 8, wherein the male end of the rod is configured to at least partially enter the chuck of the rotary tool.

10. The device of claim 9, wherein the jaws are configured to grip the male end of the rod with radial symmetry.

11. The device of claim 10, wherein the geometric-shaped terminus of the male end is configured to register with the jaws of the chuck in a snug relationship.

12. The device of claim 11, wherein the rod has sufficient strength to transfer torque from the rotary tool to the rotatable drive shaft.

13. The device of claim 12, wherein the trailer crank is operable to enable raising and lowering a trailer when the rod rotates the rotatable drive shaft.

14. A trailer crank extension device, the device comprising:
a rod defined by a male end and a female end, the male end defining a geometric-shaped terminus, the female end defining a channel and a geometric-shaped inner surface;
a cylindrical clamp configured to encapsulate at least a portion of the female end of the rod and at least a portion of a rotatable drive shaft of a trailer crank, the cylindrical clamp comprising two sections adapted to at least partially encapsulate the female end of the rod and the rotatable drive shaft, the sections comprising a male end section and a female end section, the male end section comprising a texture for enhancing grip of the cylindrical clamp, the female end section defining a slot adapted to enable passage of at least a portion of the trailer crank, the cylindrical clamp forming a tunnel for enabling passage of the rod and the rotatable drive shaft therethrough,
whereby the cylindrical clamp detachably attaches the rod to the rotatable drive shaft;
a strap defined by a pair of free ends, the strap configured to at least partially wrap around the cylindrical clamp and the female end of the rod,
whereby the strap helps fasten the cylindrical clamp to the trailer crank; and
multiple fasteners configured to fasten the free ends of the strap together.

15. The device of claim 14, further comprising a rotary tool, the rotary tool comprising a chuck having multiple jaws.

16. The device of claim 15, wherein the male end of the rod is configured to at least partially enter the chuck of the rotary tool.

17. The device of claim 16, wherein the jaws are configured to grip the male end of the rod with radial symmetry.

18. The device of claim 17, wherein the geometric-shaped terminus of the male end is configured to register with the jaws of the chuck in a snug relationship.

19. The device of claim 18, wherein the rod has sufficient strength to transfer torque from the rotary tool to the rotatable drive shaft.

20. A trailer crank extension device, the device consisting of:
a rod defined by a male end and a female end, the male end defining a geometric-shaped terminus, the female end defining a channel and a geometric-shaped inner surface;
a cylindrical clamp configured to encapsulate at least a portion of the female end of the rod and at least a portion of a rotatable drive shaft of a trailer crank, the cylindrical clamp comprising two sections adapted to at least partially encapsulate the female end of the rod and the rotatable drive shaft, the sections comprising a male end section and a female end section, the male end section comprising a texture for enhancing grip of the cylindrical clamp, the female end section defining a slot adapted to enable passage of at least a portion of the trailer crank, the cylindrical clamp forming a tunnel for enabling passage of the rod and the rotatable drive shaft therethrough,
whereby the cylindrical clamp detachably attaches the rod to the rotatable drive shaft;
a flexible strap defined by a pair of free ends, the strap configured to at least partially wrap around the cylindrical clamp and the female end of the rod,
whereby the strap helps fasten the cylindrical clamp to the trailer crank;
multiple fasteners configured to fasten the free ends of the strap together; and
a rotary tool comprising a chuck having multiple jaws, the male end of the rod being configured to at least partially enter the chuck of the rotary tool,
whereby the rod is configured for interposition between the chuck and the rotatable drive shaft,
whereby the geometric-shaped terminus of the male end is configured to register with the jaws of the chuck in a snug relationship,
the rod has sufficient strength to transfer torque from the rotary tool to the rotatable drive shaft.
